(19) United States
(12) Patent Application Publication
(10) Pub. No.: US 2019/0080635 A1
(43) Pub. Date: Mar. 14, 2019

(54) Safety Flag Assembly

(71) Applicants: David Deming, Lee, NH (US); Stephanie Deming, Lee, NH (US)

(72) Inventors: David Deming, Lee, NH (US); Stephanie Deming, Lee, NH (US)

(21) Appl. No.: 15/701,806

(22) Filed: Sep. 12, 2017

(51) Int. Cl. G09F 17/00; B60R 13/00

(52) U.S. Cl. CPC G09F 17/00; G09F 2017/0083; G09F 2017/0075; B60R 13/00

(57) ABSTRACT

A safety flag assembly is disclosed. In accordance with some embodiments, the disclosed assembly may include an attachment element, such as a spring clamp, configured to be attached to a given mounting surface. The assembly also may include a safety flag, which may meet or exceed local and/or federal Department of Transportation (DOT) requirements. The assembly further may include a coupling element, such as a carabiner or keyring, which may be inserted through an eyelet of the safety flag and an aperture of the attachment element to effectuate coupling thereof in a temporary or permanent manner. In some instances, the safety flag may be further compatible for use, for example, with a dowel/rod, flagpole, bungee cord, or rope in providing safety marking.

### FIELD OF THE DISCLOSURE

The present disclosure relates to transportation safety and more particularly to safety flags utilized in cargo transportation.

### BACKGROUND

Under current regulations, certain motor vehicles transporting a load are required to have the load marked with one or more warning flags compliant with certain size and color requirements. Compliance with local and federal Department of Transportation (DOT) regulations is routinely monitored and strictly enforced to ensure the safety of motorists on public roadways.

### SUMMARY

The subject matter of this application may involve, in some cases, interrelated products, alternative solutions to a particular problem, and/or a plurality of different uses of a single system or article.

One example embodiment provides a safety flag assembly. The safety flag assembly includes: an attachment element having at least one aperture formed therein, wherein the attachment element is configured to be attached to a mounting surface; a safety flag having at least one eyelet formed therein; and a coupling element configured to be received by the at least one aperture and the at least one eyelet in a manner that couples the safety flag to the attachment element. In some cases, the attachment element is a spring clamp including a pair of opposing arm portions biased together by a biasing element, wherein at least one of the arm portions has the at least one aperture formed therein. In some such cases, at least one of the arm portions includes a tip portion that at least one of: has a protective covering configured to prevent damage to the mounting surface when the attachment element is attached thereto; and is pivotable along at least one axis. In some other such cases, the coupling element is a carabiner configured to he inserted through the at least one aperture and the at least one eyelet. In some such cases, the carabiner includes a wire gate. In some other such cases, the carabiner includes a straight gate. In some other such cases, the carabiner is either of auto-locking type or manual-locking type. In some instances, the coupling element is a formed wire fastener configured to be inserted through the at least one aperture and the at least one eyelet. In some instances, the coupling element is a wire tie configured to be inserted through the at least one aperture and the at least one eyelet. In some cases, the coupling element is a key ring configured to be inserted through the at least one aperture and the at least one eyelet. In some instances, the at least one eyelet is reinforced with a grommet. In some cases, the at least one eyelet is reinforced with at least one of stitching, weaving, wrapping, and thickening of localized material of the safety flag. In some instances, the at least one eyelet consists of: a first eyelet disposed proximate a first corner of the safety flag and reinforced with a first grommet; and a second eyelet disposed proximate a second corner of the safety flag and reinforced with a second grommet. In some cases, the safety flag: has an area of about 16 in² or more; and is of either a fluorescent orange, red, or green color. In some instances, the safety flag: includes a pocket configured to interface with at least one of a dowel and a flagpole; and is configured to be decoupled from the coupling element and coupled instead with the at least one of the dowel and the flagpole by interfacing of the pocket with the at least one of the dowel and the flagpole.

Another example embodiment provides a safety flag assembly. The safety flag assembly includes a spring clamp including an arm portion having an aperture formed therein. The safety flag assembly also includes a safety flag having an eyelet formed therein, wherein the safety flag: is of substantially square geometry; has an area of about 18 in² or more; and is of either a fluorescent orange, red, or green color. The safety flag assembly further includes a coupling element configured to couple the safety flag to the spring clamp. In some cases, the eyelet is: disposed proximate a corner of the safety flag; and reinforced with at least one of a grommet, stitching, weaving, wrapping, and thickening of localized material of the safety flag. In some instances, the eyelet is: disposed proximate an edge of the safety flag; and reinforced with at least one of a grommet, stitching, weaving, wrapping, and thickening of localized material of the safety flag. In some cases, the coupling element is a carabiner configured to be inserted through the aperture and the eyelet. In some instances, the spring clamp and the coupling element are of monolithic construction.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

FIG. 1 illustrates an isometric view of a safety flag assembly configured in accordance with an embodiment of the present disclosure.

FIG. 2 illustrates an exploded partial isometric view of a safety flag assembly configured in accordance with an embodiment of the present disclosure.

FIG. 3 illustrates an isometric view of a safety flag assembly attached to an example mounting surface in accordance with an embodiment of the present disclosure.

These and other features of the present embodiments will be understood better by reading the following detailed description, taken together with the figures herein described. In the drawings, each identical or nearly identical component that is illustrated in various figures may be represented by a like numeral. For purposes of clarity, not every component may be labeled in every drawing. Furthermore, as will be appreciated in light of this disclosure, the accompanying drawings are not intended to be drawn to scale or to limit the described embodiments to the specific configurations shown.

### DETAILED DESCRIPTION

A safety flag assembly is disclosed. In accordance with some embodiments, the disclosed assembly may include an attachment element, such as a spring clamp, configured to be attached to a given mounting surface. The assembly also may include a safety flag, which may meet or exceed local and/or federal Department of Transportation (DOT) requirements. The assembly further may include a coupling element, such as a carabiner or keyring, which may be inserted through an eyelet of the safety flag and an aperture of the attachment element to effectuate coupling thereof in a temporary or permanent manner. In some instances, the safety flag may be further compatible for use, for example, with a dowel/rod, flagpole, bungee cord, or rope in providing safety marking. Numerous configurations and variations will be apparent in light of this disclosure.

General Overview

A safety flag assembly is disclosed. In accordance with some embodiments, the disclosed assembly may include an attachment element, such as a spring clamp, configured to be attached to a given mounting surface. The assembly also may include a safety flag, which may meet or exceed local and/or federal Department of Transportation (DOT) requirements. The assembly further may include a coupling element, such as a carabiner or keyring, which may be inserted through an eyelet of the safety flag and an aperture of the attachment element to effectuate coupling thereof in a temporary or permanent manner. In some instances, the safety flag may be further compatible for use, for example, with a dowel/rod, flagpole, bungee cord, or rope in providing safety marking.

In accordance with some embodiments, the disclosed assembly may be configured for use, for example, in transporting cargo on roadways. For instance, the disclosed assembly may be attached to any of a wide range of cargo, such as lumber, pipes, kayaks, sheetrock, large appliances, or any other loads that may be transported on the roadway. In accordance with some embodiments, the disclosed assembly may be configured for quick and easy attachment, detachment, and adjustment. The disclosed assembly may be, at least in some instances, strong enough to remain attached to cargo (or other mounting surface) in high-speed transportation yet safe enough to prevent (or otherwise minimize) damage to the mounting surface. Moreover, the disclosed assembly may be any one, or combination, of weather-resistant, water-resistant, and ultraviolet light-resistant, providing a durable, reusable option for safety marking.

In some instances, a safety flag assembly provided as variously described herein may be configured, for example, as: (1) a partially completely assembled unit; and/or (2) a kit or other collection of discrete components (e.g., an attachment element, a coupling element, and a safety flag) which may be operatively coupled as desired.

Assembly Structure and Operation

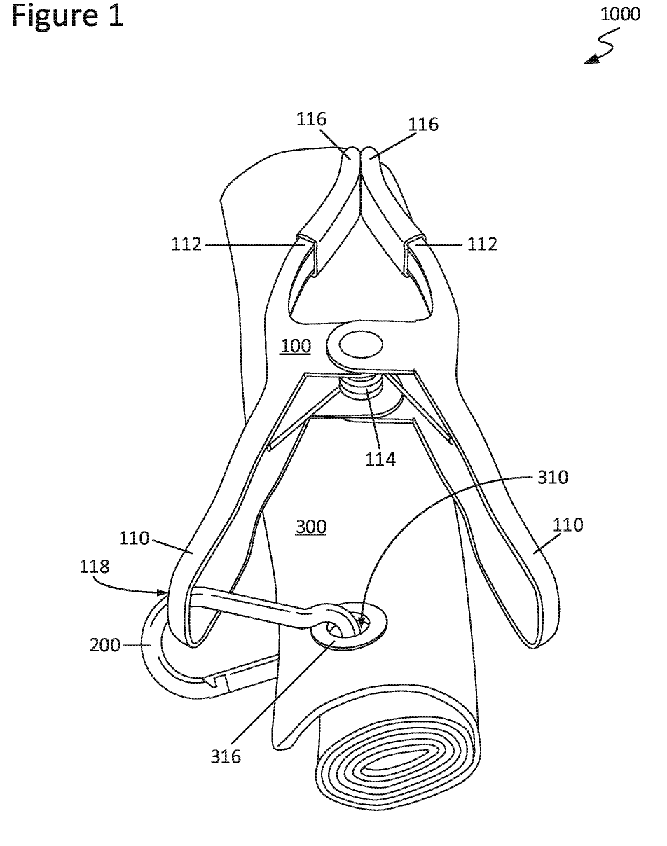

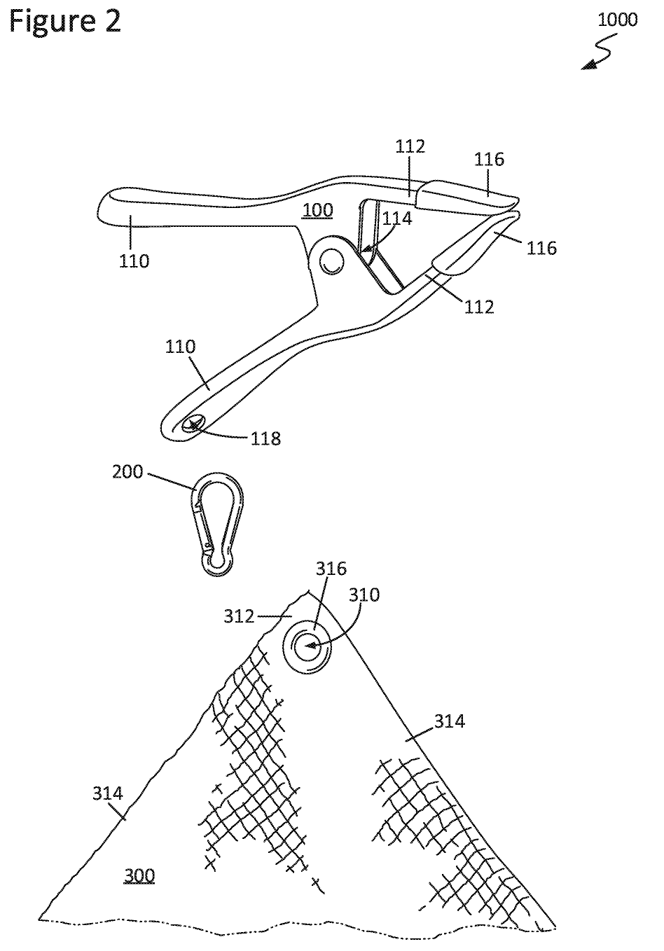

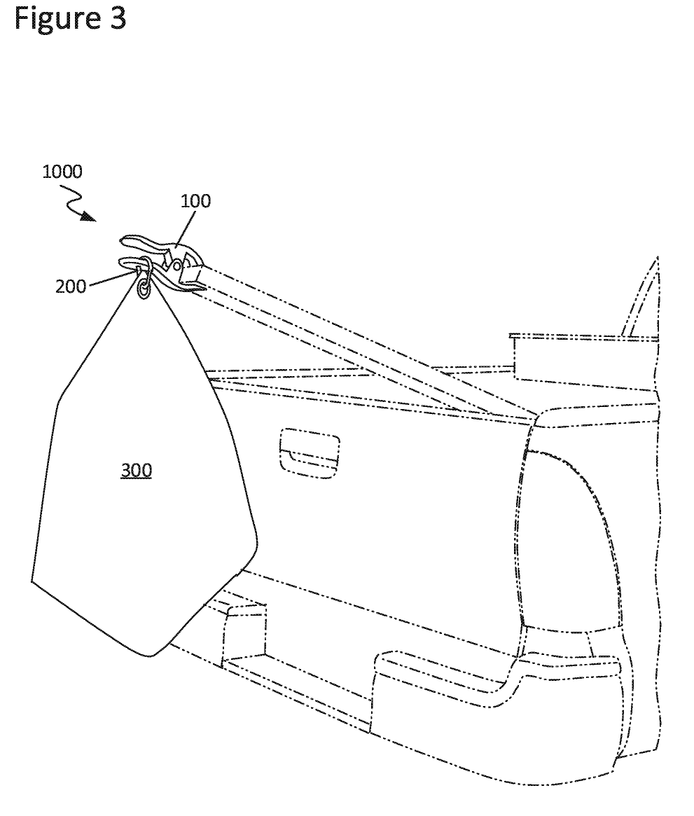

FIGS. 1-2 illustrate several views of a safety flag assembly 1000 configured in accordance with an embodiment of the present disclosure. As can be seen, assembly 1000 includes an attachment element 100, a coupling element 200, and a safety flag 300, each discussed in turn below. As discussed herein, assembly 1000 may be configured, in accordance with some embodiments, to be affixed to a given mounting surface in a temporary or permanent manner. For instance, consider FIG. 3, which illustrates an isometric view of a safety flag assembly 1000 attached to an example mounting surface in accordance with an embodiment of the present disclosure. As can be seen, assembly 1000 may be configured to be affixed to cargo, such as lumber, pipes, boats, or machinery, among other examples, when transporting that cargo, for instance, on a roadway. Numerous suitable uses for assembly 1000 will be apparent in light of this disclosure.

Attachment element 100 may be configured, in accordance with some embodiments, to be attached to a given mounting surface, affixing assembly 1000 thereto in a temporary or permanent manner. To that end, attachment element 100 may be configured to interface, directly or indirectly, with the target mounting surface, as desired. In some cases, attachment element 100 may interface with the mounting surface in a manner that provides for a given degree of flexing or pivoting, though in other cases, a rigid or immovable interfacing may be provided. In a more general sense, attachment element 100 may be configured to be attached to a given mounting surface in a manner that prevents (or otherwise reduces) the opportunity for unwanted movement of attachment element 100 in relation to the surface.

In some embodiments, attachment element 100 may be a spring clamp. As can be seen, attachment element 100, as a spring clamp, may have two opposing arm portions 110, each of which may terminate in a tip portion 112. Tip portions 112 may be biased toward one another (e.g., to maintain the spring clamp in its closed position) via a biasing element 114, such as a spring. The throat depth and clamping force of attachment element 100, as a spring clamp, may be customized, as desired for a given target application or end-use. In some instances, attachment element 100 may have a jaw opening of about 2 inches or less, whereas in some other instances, a jaw opening of about 2 inches or greater may be provided. In some cases, a given tip portion 112 optionally may have a protective element 116, such as a cap, sleeve, or wrap, to interface with the mounting surface in a manner which prevents (or otherwise reduces) potential damage to the mounting surface when attachment element 100, as a spring clamp, is attached thereto. In some cases, a given tip portion 112 optionally may be fixed or able to pivot (e.g., along one or more axes), as desired for a given target application or end-use. In a more general sense, attachment element 100 may be configured, in accordance with some embodiments, to prevent (or otherwise reduce) the opportunity for slipping or twisting when attached to the mounting surface.

It should be noted, however, that attachment element 100 is not intended to be limited only to a spring clamp configuration. For instance, in accordance with some other embodiments, attachment element 100 may be a C-clamp, an F-clamp, a G-clamp, a quick-action hand clamp, a quick-grip clamp, a one-handed bar clamp, a trigger clamp, a ratcheting clamp, or a toggle clamp, to name a few options. Any of such clamps may be configured as typically done. In some embodiments in which attachment element 100 includes one or more clamp pads, such clamp pad(s) optionally may be fixed or able to pivot (e.g., along one or more axes), as desired for a given target application or end-use.

In accordance with some embodiments, attachment element 100 may include one or more coupling points at which coupling element 200 (discussed below) may be coupled. For instance, in the example embodiment illustrated via FIGS. 1-3, attachment element 100, as a spring clamp, may include one or more apertures 118 formed in at least one of its arm portions 110 (e.g., at a distal end thereof, opposing a given tip portion 112), through which coupling element 200 may be inserted. The dimensions and geometry of a given aperture 118 may be customized, as desired for a given target application or end-use. It should be noted, however, that the present disclosure is not intended to be limited only to aperture(s) 118 as coupling points, for in accordance with some other embodiments, other coupling means, such as tab-and-retainer coupling, bayonet coupling, magnetic coupling, hook-and-loop fastener coupling, or retention pin coupling, among other options, may be utilized in coupling attachment element 100 and coupling element 200.

As will be appreciated in light of this disclosure, the material construction of attachment element 100 may be customized, as desired for a given target application or end-use. For instance, attachment element 100 may be constructed, in part or in whole, from any one or combination of a metal (e.g., a steel), a polymer (e.g., a plastic), a composite, or other suitable construction material(s), as will be apparent in light of this disclosure. When optionally included, a given protective element 116 on a given tip portion 112 of attachment element 100 may be constructed from any one, or combination, of a rubber, a plastic, vinyl, or silicone, for instance. In some embodiments, attachment element 100 may be any one, or combination, of water-resistant, weather-resistant, and ultraviolet light-resistant. In some cases, attachment element 100 may be coated, in part or in whole, with a protective material. Other suitable configurations for attachment element 100 will depend on a given target application or end-use and will be apparent in light of this disclosure.

Coupling element 200 may be configured, in accordance with some embodiments, to couple with attachment element 100 (as noted above) and with safety flag 300 (discussed below). In this manner, coupling element 200 may serve to connect attachment element 100 and safety flag 300 in providing assembly 1000. Coupling of coupling element 200 with attachment element 100 and/or safety flag 300 may be provided in a temporary or permanent manner, as desired.

In some embodiments, coupling element 200 may be a carabiner of a given size and shape. Coupling element 200, as a carabiner, may be of wire-gate, straight-gate, or other suitable gate type. Moreover, coupling element 200, as a carabiner, may be of auto-locking, manual-locking, or non-locking type, as desired. In cases of a lockable carabiner configuration, coupling element 200 may be of screw-lock, twist-lock, push-lock, twist-and-push lock, or magnetic-lock type, to name a few options.

It should be noted, however, that coupling element 200 is not intended to be limited only to a carabiner configuration. For instance, in some other embodiments, coupling element 200 may be a formed wire fastener, such as a key ring (e.g., a split ring, a cotter ring). In some other embodiments, coupling element 200 may be a wire tie, such as a zip tie. In some other embodiments, coupling element 200 may be a clasp, such as a bar-and-ring clasp, a hook-and-eye clasp, a screw/threaded clasp, a magnetic clasp, a spring ring clasp, a buckle clasp, a barrel clasp, a lobster claw clasp, or a hinged clasp, to name a few. In some other embodiments, coupling element 200 may be a chain (e.g., a ball-and-socket chain). As will be appreciated in light of this disclosure, coupling element 200 may include any of the various example materials discussed above, for instance, with respect to attachment element 100, in accordance with some embodiments.

In some embodiments, assembly 1000 may be configured such that attachment element 100 and coupling element 200 are of polylithic construction, constituting separate pieces that may be operatively coupled with one another (e.g., as an assembly), in a temporary or permanent manner, as previously discussed. In some other embodiments, however, assembly 1000 may be configured such that attachment element 100 and coupling element 200 together are of monolithic construction, constituting a singular unitary piece. That is, attachment element 100 may have a coupling element 200 integrated therewith and available for coupling with safety flag 300 (discussed below). In some cases, this may reduce the total quantity of independent constituent pieces of assembly 1000 (e.g., rather than being, for instance, a three-piece assembly 1000, a two-piece assembly 1000 may be provided). Other suitable configurations for coupling element 200 will depend on a given target application or end-use and will be apparent in light of this disclosure.

Safety flag 300 may have any of a wide range of configurations. In accordance with some embodiments, safety flag 300 may be, for instance, a safety, warning, or hazard flag configured for use in roadway transportation and, to that end, may meet or exceed state and/or federal Department of Transportation (DOT) regulations. In some embodiments, safety flag 300 may be substantially square in shape, having an area of about 16 in² or more (e.g., 18 in² or more) and being fluorescent orange, red, green, or some other suitable high-visibility color. It should be noted, however, that safety flag 300 need not be DOT-compliant, nor need it be a safety, warning, or hazard flag necessarily. In a more general sense, safety flag 300 may be a flag of any shape (e.g., rectangular, triangular, circular, or elliptical, among other options), size, and color, as desired for a given target application or end-use.

As previously noted, assembly 1000 may be configured such that safety flag 300 may be coupled with coupling element 200. To that end, safety flag 300 may include one or more eyelets 310. A given eyelet 310 may be, generally, a small hole through which coupling element 200 may be inserted, in accordance with some embodiments. The size, shape, and location of a given eyelet 310 may be customized, as desired for a given target application or end-use. Moreover, the quantity and arrangement of eyelets 310 may be customized. In an example case, safety flag 300 may include an eyelet 310 at a corner 312 thereof. In another example case, safety flag 300 may include an eyelet 310 at an edge 314 thereof. In yet another example case, safety flag 300 may include two eyelets 310, each disposed proximate a different corner 312 of safety flag 300.

In some cases, a given eyelet 310 may be reinforced at its perimeter. For instance, in some embodiments, a given eyelet 310 may be reinforced with a grommet 316, which optionally may be a toothed grommet. In some embodiments, a given eyelet 310 may be reinforced with stitching, weaving, wrapping, or other thickening of the localized material/structure of safety flag 300.

The material construction of safety flag 300 may be customized, as desired for a given target application or end-use. Safety flag 300 may be woven or non-woven and made of any one, or combination, of a wide range of suitable natural or synthetic materials. In some embodiments, safety flag 300 may be made of cloth or a polymer (e.g., a plastic, such as nylon). In some embodiments, safety flag 300 may be a mesh (e.g., as generally shown in FIG. 2). Numerous configurations and materials for safety flag 300 will be apparent in light of this disclosure.

It may be desirable, at least in some instances, to ensure that safety flag 300 is constructed in a manner resistant to cracking, peeling, and fraying, for example, to prolong its effective lifespan. In some cases, safety flag 300 may be any one, or combination, of water-resistant, weather-resistant, and ultraviolet light-resistant. In some instances, safety flag 300 may be coated, in part or in whole, with a protective material, such as, for example, polyvinyl chloride (PVC). In some embodiments, safety flag 300 optionally may be reinforced, in part or in whole, via a stiffener rod or web or other reinforcement body. In some embodiments, one or more edges 314 (and/or corners 312) of safety flag 300 optionally may be reinforced, in part or in whole, via bar tack or other doubled stitching or other suitable means, as will be apparent in light of this disclosure. In some embodiments, safety flag 300 may have one or more visible markings, such as alphanumeric, icon, image, color, logo, or other suitable marker(s). In some embodiments, safety flag 300, including any visible marking thereon, may be reflective, in part or in whole.

In accordance with some embodiments, safety flag 300, as a constituent of assembly 1000, may be configured for use not only with coupling element 200 and attachment element 100, but also optionally with any one, or combination, of a dowel/rod, a bungee cord, or a rope, for instance. In an example case, safety flag 300 optionally may include a rod pocket (or other suitable rod-interfacing portion) configured to receive a dowel, flagpole, or other flag-bearing body. In this manner, safety flag 300 may be decoupled from coupling element 200 (and thus attachment element 100 and, more generally, assembly 1000) and optionally coupled instead with a dowel/rod, as typically may be presented in other safety flag marking arrangements, via insertion of the dowel/rod in the rod pocket or via a suitable fastener (e.g., a staple, a clamp ring, etc.). Moreover, such a safety flag 300 still may be configured for quick and easy use in mounting to a given mounting surface via attachment element 100 (as a constituent member of assembly 1000) and coupling element 200. In this sense, assembly 1000 may include a safety flag 300 suitable for use within multiple roadway transportation contexts and providing multiple safety marking options.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein.

What is claimed is:

1. A safety flag assembly comprising:
an attachment element having at least one aperture formed therein, wherein the attachment element is configured to be attached to a mounting surface;
a safety flag having at least one eyelet formed therein; and
a coupling element configured to be received by the at least one aperture and the at least one eyelet in a manner that couples the safety flag to the attachment element.

2. The assembly of claim 1, wherein the attachment element is a spring clamp comprising a pair of opposing arm portions biased together by a biasing element, wherein at least one of the arm portions has the at least one aperture formed therein.

3. The assembly of claim 2, wherein at least one of the arm portions includes a tip portion that at least one of:
has a protective covering configured to prevent damage to the mounting surface when the attachment element is attached thereto; and
is pivotable along at least one axis.

4. The assembly of claim 2, wherein the coupling element is a carabiner configured to be inserted through the at least one aperture and the at least one eyelet.

5. The assembly of claim 4, wherein the carabiner includes a wire gate.

6. The assembly of claim 4, wherein the carabiner includes a straight gate.

7. The assembly of claim 4, wherein the carabiner is either of auto-locking type or manual-locking type.

8. The assembly of claim 2, wherein the coupling element is a formed wire fastener configured to be inserted through the at least one aperture and the at least one eyelet.

9. The assembly of claim 2, wherein the coupling element is a wire tie configured to be inserted through the at least one aperture and the at least one eyelet.

10. The assembly of claim 2, wherein the coupling element is a key ring configured to be inserted through the at least one aperture and the at least one eyelet.

11. The assembly of claim 1, wherein the at least one eyelet is reinforced with a grommet.

12. The assembly of claim 1, wherein the at least one eyelet is reinforced with at least one of stitching, weaving, wrapping, and thickening of localized material of the safety flag.

13. The assembly of claim 1, wherein the at least one eyelet consists of:
a first eyelet disposed proximate a first corner of the safety flag and reinforced with a first grommet; and
a second eyelet disposed proximate a second corner of the safety flag and reinforced with a second grommet.

14. The assembly of claim 1, wherein the safety flag:
has an area of about 16 in² or more; and
is of either a fluorescent orange, red, or green color.

15. The assembly of claim 1, wherein the safety flag:
includes a pocket configured to interface with at least one of a dowel and a flagpole; and
is configured to be decoupled from the coupling element and coupled instead with the at least one of the dowel and the flagpole by interfacing of the pocket with the at least one of the dowel and the flagpole.

16. A safety flag assembly comprising:
a spring clamp comprising an arm portion having an aperture formed therein;
a safety flag having an eyelet formed therein, wherein the safety flag:
is of substantially square geometry;
has an area of about 18 in² or more; and
is of either a fluorescent orange, red, or green color; and
a coupling element configured to couple the safety flag to the spring clamp.

17. The assembly of claim 16, wherein the eyelet is:
disposed proximate a corner of the safety flag; and
reinforced with at least one of a grommet, stitching, weaving, wrapping, and thickening of localized material of the safety flag.

18. The assembly of claim 16, wherein the eyelet is:
disposed proximate an edge of the safety flag; and
reinforced with at least one of a grommet, stitching, weaving, wrapping, and thickening of localized material of the safety flag.

19. The assembly of claim 16, wherein the coupling element is a carabiner configured to be inserted through the aperture and the eyelet.

20. The assembly of claim 16, wherein the spring clamp and the coupling element are of monolithic construction.
